(19) United States
(12) Patent Application Publication
(10) Pub. No.: US 2018/0205801 A1
(43) Pub. Date: Jul. 19, 2018

(54) APPARATUS AND METHOD FOR CONNECTING AT LEAST TWO SYSTEMS BY CONVERTING DATA

(71) Applicant: NEC LABORATORIES EUROPE GMBH, Heidelberg (DE)

(72) Inventors: Ernoe Kovacs, Stuttgart (DE); Martin Bauer, Eppelheim (DE)

(21) Appl. No.: 15/742,069

(22) PCT Filed: Jul. 6, 2016
(86) PCT No.: PCT/EP2016/066037

§ 371 Date: Jan. 5, 2018

(30) Foreign Application Priority Data
Jul. 6, 2015 (EP) 15175540.2

(51) Int. Cl. H04L 29/08; H04L 12/24

(52) U.S. Cl. CPC H04L 67/2823; H04L 41/0213; H04L 67/12; H04L 41/0806

(57) ABSTRACT

An interworking entity (IE) connects at least two systems like networks. Each system comprises at least one device and the systems use data based on different data models. The IE is adapted to convert data based on a first data model to data based on a second data model such that the data is processible by the respective devices in the systems. The IE is operable to evaluate mapping data within data to be transmitted from a first one of the at least two systems to a second one of the at least two systems, and to map, based on the evaluated mapping data, data compatible to the first data model from a first network to data compatible with the second data model.

### CROSS-REFERENCE TO PRIOR APPLICATIONS

This application is a U.S. National Stage Application under 35 U.S.C. § 371 of International Application No. PCT/EP2016/066037 filed on Jul. 6, 2016, and claims benefit to European Patent Application No. EP 15175540.2 filed on Jul. 6, 2015. The International Application was published in English on Jan. 12, 2017 as WO 2017/005817 A1 under PCT Article 21(2).

### FIELD

The present invention relates to an interworking entity, ‘IE’, for connecting at least two systems like networks, each system comprising at least one device, wherein said systems use data based on different data models, wherein said IE is adapted to convert data based on a first data model to data based on a second data model such that data can be processed by the respective devices in said systems.

The present invention further relates to a method for connecting at least two systems like networks, each system comprising at least one device, wherein said systems use data with different data models, wherein a data based on a first data model is at least partly converted to data based on a second data model such that data can be processed by devices within said system.

The present invention further relates to a non-transitory computer readable medium storing a program causing a computer to execute a method for connecting at least two systems like networks, each system comprising at least one device, wherein said systems use data with different data models, wherein a data based on a first data model is at least partly converted to data based on a second data model such that data can be processed by devices within said systems.

The present invention even further relates to a non-transitory computer readable medium storing a program causing a computer to execute a method for operating an interworking entity, IE, for connecting at least two systems like networks, each system comprising at least one device, wherein said systems use data elements based on different data models, wherein said IE is adapted to convert data based on a first data model to data based on a second data model such that data can be processed by the respective devices in said systems.

Although applicable to any kind of system, the present invention will be described with regard to a first system based on OMA NGSI-9/10 standard as first data model and a second system based on oneM2M as second data model.

On the one hand the European Future Internet platform FIWARE uses the OMA NGSI-9/10 standards as their core interface to expose context and Internet-of-Things IoT information. On the other hand oneM2M is standardizing the protocols and APIs for an international M2M platform. Achieving interoperability between these two systems would benefit both sides as it
(a) would allow using oneM2M devices from FIWARE.
(b) immediately increases the reach of oneM2M to thousands of applications, startups, and systems

However, the two systems have some fundamental differences in the underlying data model, the arbitration level and the application programming interfaces API:
(a) The Data Model
   One design principle of oneM2M is to be data agnostic. All data is treated as a black box and transferred in a base64 encoded format. This decouples application logic from oneM2M middleware logic, but also prevents the middleware from making use of the data model information, e.g. in discovery processes or in mashups.
   OMA NGSI-9/10 on the other hand is using structured data and provides functions for searching and discovering data based on their internal structures (e.g. entity types).
(b) The Abstraction Level
   OMA NGSI-9/10 is based on modeling high-level real-world entities assuming that their attributes are associated to concrete data sources like sensors. When done right, the data model can therefore be on the level of real-world entities instead of low-level devices.
   OneM2M in general is as mentioned before data agnostic, but the structure of the system in ASN-/MN-/IN-CSEs is leaning towards a device centric data model. In a device-centric data-model, the information exchanged is related to the device generating the information and not to a real-world entity and
(c) APIs
   On the API level, both standards support on an abstract level the following functions:
      “Query” for information: a requesting application asks for the latest value of a given data source,
      “Subscribe/Notify”: a requesting application asks for “Notifications” whenever a given data source changes.
      “Updates”: data sources send changes to their internal state and expect that the system knows how to handle it.

Though on a high level, the operations look similar, the details of implementation vary a lot.

Conventionally interoperability between the two systems has been achieved by means of an interworking proxy.

FIG. 1 shows such a conventional interworking proxy for achieving interoperability between a DeviceManagingSystem and an EntityExposingSystem. The DeviceManagingSystem manages attached devices like sensors and actuators. It provides facilities to access information and issue commands. The devices can be sensors, actuators, user interface devices, mobile phones, databases, social network servers, or other. The EntityExposingSystem is exposing data to applications.

For instance the DeviceManagingSystem may be a oneM2M system and the EntityExposingSystem may be an NGSI-based System.

The interworking proxy conventionally a) reads NGSI information and creates a respective oneM2M data container with exactly this NGSI information, and b) reads a oneM2M data container with NGSI information and forwards this to the NGSI system.

However the interworking proxy comprises all the knowledge about which oneM2M information is mapped to which OMA NGSI attribute. It comprises the logic of retrieval and updating. Extensions can be only done by changing the converter for mapping, either the used code base or maybe by supplying additional configuration files. Neither the oneM2M system nor the NGSI system knows about the interworking proxy.

### SUMMARY

In an embodiment, the present invention provides an interworking entity (IE) for connecting at least two systems like networks. Each system comprises at least one device and the systems use data based on different data models. The IE is adapted to convert data based on a first data model to data based on a second data model such that the data is processible by the respective devices in the systems. The IE is operable to evaluate mapping data within data to be transmitted from a first one of the at least two systems to a second one of the at least two systems, and to map, based on the evaluated mapping data, data compatible to the first data model from a first network to data compatible with the second data model.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a conventional system;

FIG. 2 shows a part of a system according to an embodiment of the present invention;

FIG. 3 shows a part of a system according to a further embodiment of the present invention;

FIG. 4 shows a part of a system according to a further embodiment of the present invention;

FIG. 5 shows a part of a system according to a further embodiment of the present invention; and

FIG. 6 shows a part of a system according to a further embodiment of the present invention.

### DETAILED DESCRIPTION

The inventors have recognized that the conventional setup or structure causes inter alia the following problems:
It is sensitive to data model changes in the data models on both sides. When one of the models is changed, the converter needs to be updated.
Effort Scaling: Integration effort is linear to set of mapped attributes: for each new mapping of oneM2M data to an OMA NGSI attribute, the converter needs to be changed
Extensibility: extending the system with new values is basically a change of the converter.
Prevention of Re-Use: as the integration information is basically encapsulated inside the converter, it cannot be easily re-used by others.
Interworking Support: as neither of the two interworking system is aware of the interworking, they cannot support it with e.g. additional information for interworking

One of the problems addressed by embodiments of the present invention is therefore to improve data exchange between systems based on different data models. A further problem addressed by embodiments of the present invention is to enhance efficiency of the operation of the interworking proxy. A further problem addressed by embodiments of the present invention is to provide an easier configuration and operation.

In an embodiment the present invention provides an interworking entity, ‘IE’, for connecting at least two systems like networks, each system comprising at least one device, wherein said systems use data based on different data models, wherein said IE is adapted to convert data based on a first data model to data based on a second data model such that data can be processed by the respective devices in said systems, wherein said IE is operable to evaluate mapping data, preferably metadata, within data to be transmitted from one system to the other system and to map—based on said evaluated mapping data, preferably metadata,—said data compatible to said first data model from said first network to data compatible with said second data model.

In a further embodiment the present invention provides a method for connecting at least two systems like networks, each system comprising at least one device, wherein said systems use data with different data models, wherein a data based on a first data model is at least partly converted to data according to a second data model such that data can be processed by devices within said systems, wherein for data to be transmitted from a first network and based on said first data model to a second network the following steps are performed:
a) Inserting mapping data, preferably metadata, into registry information of said first network for data to be transmittable to said second network,
b) Discovering the data elements to be transmitted that need to be converted by an interworking entity, ‘IE’, located between and connected to each of said first and second system,
c) Extracting mapping data, preferably metadata, of said data elements, and
d) Converting based on said extracted metadata the data elements based on said first data model into data elements based on said second data model.

In a further embodiment the present invention provides a non-transitory computer readable medium storing a program causing a computer to execute a method for connecting at least two systems like networks, each system comprising at least one device, wherein said systems use data with different data models, wherein data based on a first data model is at least partly converted to data based on a second data model such that data can be processed by devices within said systems, wherein for data to be transmitted from a first network and based on said first data model to a second network the following steps are performed:
a) Inserting mapping data, preferably metadata, into registry information of said first network for data to be transmittable to said second network,
b) Discovering the data elements to be transmitted that need to be converted by an interworking entity, ‘IE’, located between and connected to each of said first and second system,
c) Extracting mapping data, preferably metadata, of said data elements, and
d) Converting based on said extracted mapping data, preferably metadata, the data elements based on said first data model into data elements based on said second data model.

In a further embodiment the present invention provides a non-transitory computer readable medium storing a program causing a computer to execute a method for operating an interworking entity, ‘IE’, for connecting at least two systems like networks, each system comprising at least one device, wherein said systems use data based on different data models, wherein said IE is adapted to convert data based on a first data model to data based on a second data model such that data can be processed by the respective devices in said systems, wherein

said IE is operable to
a) evaluate mapping data, preferably metadata, within data to be transmitted from one system to the other system and to
b) map—based on said evaluated mapping data, preferably metadata,—said data compatible to said first data model from said first network to data compatible with said second data model.

Embodiments of the present invention may have one or more of the following advantages:
Easy extensibility
Unsensitive to data model changes
Efficient operation of the interworking proxy
Easier configuration and maintenance.

In other words embodiments of the present invention enable to extend the data model used within two systems with information describing how the interworking proxy shall work. Embodiments of the present invention further enable internal modules of an interworking entity. Some of these modules make use of the changed data model.

Even further, embodiments of the present invention provide further components outside of the interworking proxy, e.g. the oneM2M system or the NGSI system that are used to fill the data model extensions, e.g. tools for developers, components providing automatic discovery of the data structures and automatic generation of the needed mapping information.

The term “mapping data” refers preferably in the claims, in particular in the specification to any kind of information, data or the like, which can be used for mapping.

The term “metadata” refers preferably in the claims, in particular in the specification to any kind of information, data or the like, which can be additionally used, added, embedded, etc. into existing data structures, data models or the like.

The terms “system”, “device”, etc. refer in particular in the claims, preferably in the specification to one or more devices, computing networks comprising one or more devices or the like adapted to perform computing, communicating or the like like a personal computer, a tablet, a mobile phone, a server, or the like e.g,. Connected to a computational network, said devices comprising one or more processors having one or more cores and may be connectable to a memory for storing an application which is adapted to perform corresponding steps of one or more of the embodiments of the present invention. Any application may be software-based and/or hardware-based installed in the memory on which the processor(s) can work on. The (computing) devices may be adapted in such a way that the corresponding steps to be computed are performed in an optimized way. For instance different steps may be performed in parallel with a single processor on different of its cores. Further the devices may be identical forming a single computing device. The devices or devices may also be instantiated as a virtual device running on a physical computing resource. Different devices may therefore be executed on said physical computing resource.

The term “computer readable medium” may refer to any kind of medium, which can be used together with a computation device or computer and on which information can be stored. Said information may be any kind of data which can be read into a memory of a computer. For example said information may include program code for executing with said computer. Examples of a computer readable medium are tapes, CD-ROMs, DVD-ROMs, DVD-RAMs, DVD-RWs, BluRay, DAT, MiniDisk, solid state disks SSD, floppy disks, SD-cards, CF-cards, memory-sticks, USB-sticks, EPROM. EEPROM or the like.

The term “data model” may refer in particular in the claims, preferably in the specification to any kind of data structure, information structure or the like. I particular said term refers to an abstract model organizing elements of data/data elements and e.g. standardizes how they relate to one another and if applicable to properties, devices, etc. of the real world.

Further features, advantages and further embodiments are disclosed or may become apparent in the following:

The interworking entity may further comprise an interface for communicating with a mapping editor entity via one of the systems, said mapping editor entity adapted to provide an interface for providing metadata needed for mapping of a data element of data by said IE. This allows defining a set of necessary attributes that an interworking proxy or entity needs to retrieve information, for example via the Mca interface, from the oneM2M system. This meta-data may then be submitted to the NGSI-based system in form of said additional metadata describing an NGSI attribute.

Said IE may comprise a convention explorer entity adapted to detect data elements which can be mapped based on one or more rules. This enables to detect suitable candidates for mapping based on built-in rules. For example a rule could be to check the oneM2M application type and then have an internal table to see which attributes can be mapped. Other rules could include name-based analysis.

Said convention explorer entity may be connected to a first database storing information for applying said rules on said detected data elements. This allows an easy update of the rules for detecting suitable candidates for mapping.

Said convention explorer entity may be connected to a second database storing mapping data for mapping and/or generating attribute information for data elements according to said second data model. This allows providing data conversion in an easy way: For example for an NGSI/oneM2M scenario:
Id Generation: for each oneM2M element, the respective NGSI entity id is to be found. As NGSI entity ids are mandatory, a valid mapping is needed. The finding process could be a lookup into the NGSI system or it could be a generation process that simply generates the new id.
Type Generation: for each oneM2M element the correct NGSI entity type has to be created.
   As type information is optional, this step might be skipped though it might reduce the useability of the system.
Attribute Mapping
   For Attribute mapping the name/type/value and metadata has to be generated.
      For name and type, generation conventions can be used. The below mentioned DataConversion library might generate additional information that can be used to generate the needed name/type/metadata.
      For value conversion the needed DataConversion rule can be applied in cases in which the conversion rule is not clear. The ConventionExplorer may use several known data conversion modules from a DataConversion library and test whether they deliver correct results. The transcoded information might be used to identify the correct entity id, entity type, attribute name, attribute type, and metadata.
   Further support might be delivered by a Support Knowledge Base containing information about the oneM2M data elements.
Reliability of Mapping
   To enhance reliability of the mapping information may be entered into the NGSI system and be supplied with an “conversionAutomated ” indicator, an “conventionMethodUsed” parameter, and for a “conversionReliability” parameter.
   Those parameters may then be used during the mapping and will be added to the NGSI attribute meta-data after conversion. This enables applications to identify automatically converted information and treat them accordingly.

The conversion explorer entity may comprise said first and second database. This enables centralized knowledge within the convention explorer entity and therefore within the interworking entity without having to rely on external connections, interfaces or the like.

The interworking entity may further comprise a semantic explorer entity being adapted to find semantically annotated data elements wherein based on identified semantics in said data elements mapping data for performing steps a) and b) is identified. This allows for example annotating information for mappings in data elements. For example the semantic explorer entity may access the oneM2M system for finding semantically annotated data elements. Based on the semantics the
NGSI Entity Id+Entity Type
NGSI Attribute Id+Type
Meta-data
   may be identified. If a suitable oneM2M data element is identified, it may then be announced to the NGSI-based system. Conversion attributes, e.g. “conversionAutomated”, “conventionMethodUsed”, and “conversionReliability” being used when Convention Mapping is performed may also be generated from the semantic information.

Said semantic explorer entity may be adapted to perform said semantic finding periodically and/or upon request. In other words the semantic explorer entity can run periodically or be triggered by specific events, e.g. from the oneM2M system, e.g. when some semantic information has changed.

Said metadata may comprise at least one of
A network marker specifying the first and/or second network type.
Security credentials specifying information how the IE can obtain information for mapping.
Conversion information for the first and second network specifying how to convert data.
Proxy behavior information specifying how to access information and how to transmit information.

This enables in an easy way to identify the network for credentials, etc. enabling or enhancing a mapping.

Said first system may be an NGSI system and said second system may be a oneM2M system. This enables the use of oneM2M devices from NGSI systems which increases the reach of oneM2M to a thousands of applications, startups and systems.

The discovered data elements may be filtered based on a parameter indicating automatic conversion. This enables a fast and reliable process for the filtered data elements.

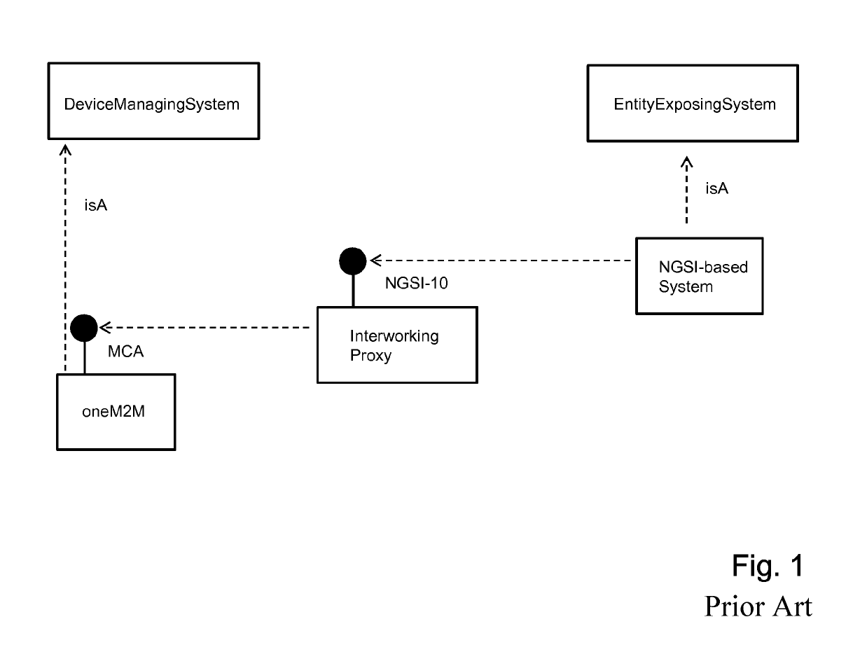

FIG. 1 shows a conventional system.

In FIG. 1 an interworking proxy is connected to an NGSI-based system based on NGSI-10 standard. Further the interworking proxy is connected via the Mca interface to the oneM2M system being a device management system. The interworking proxy reads NGSI information and creates a respective oneM2M data container with this NGSI information and reads a oneM2M data container with NGSI information and forwards this to the NGSI system for providing interoperability between the oneM2M system and the NGSI system.

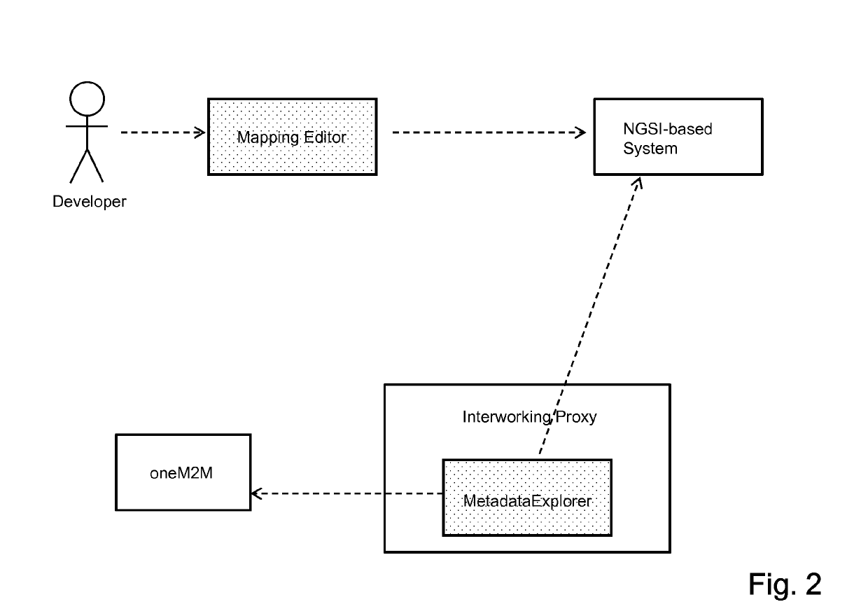

FIG. 2 shows a part of a system according to an embodiment of the present invention.

In FIG. 2 an interworking entity in form of an interworking proxy comprising a metadata explorer is shown. The interworking proxy is connected to a oneM2M system and an NGSI-based system. A developer uses a mapping editor to define a set of attributes that the interworking proxy needs to retrieve information via the Mca interface from the oneM2M system. This additional information then is submitted to the NGSI-based system in form of additional metadata describing an NGSI attribute. The metadata explorer in the interworking proxy then uses this metadata to execute the mappings between the NGSI-based system and the oneM2M system. Further the metadata explorer is adapted to scan the NGSI registry for new entries or use the NGSI subscription features to get notifications in case of a new entry with the needed metadata features. In particular the subscribe/notification features enables the metadata explorer to react in a fast way to additions or removals to the NGSI registry. The NGSI registry may be also called configuration manager.

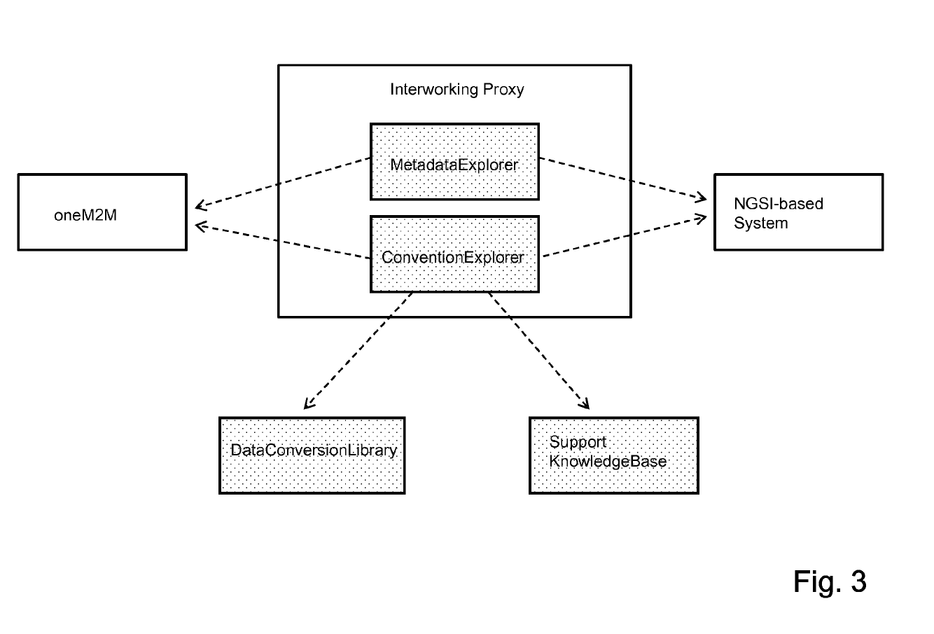

FIG. 3 shows a part of a system according to a further embodiment of the present invention.

In FIG. 3 the interworking proxy further comprises a convention explorer entity. This convention explorer entity in the interworking proxy is adapted to analyze the oneM2M structure. It tries to identify the needed mapping information and to submit it into the NGSI system automatically. This process may also include human interaction but works preferably automatically.

The “conventionExplorer” can use several built-in rules for detecting suitable candidates for mapping. One simple rule could be to check the oneM2M application type and then have an internal table to see which attributes can be mapped. Other rules could include name space analysis. In a further embodiment, the knowledge needed for those analysis steps can be externalized into a “Support KnowledgeBase” so that the convention explorer can be easily enhanced with new knowledge.

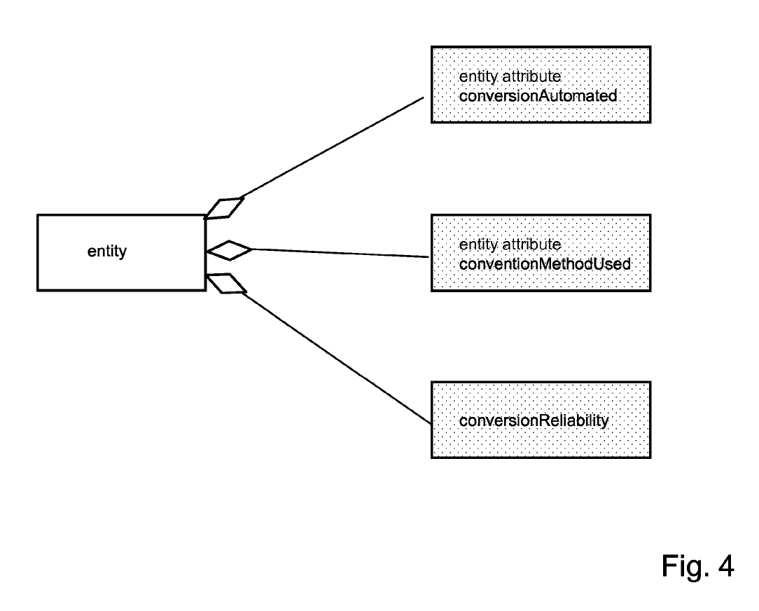

FIG. 4 shows a part of a system according to a further embodiment of the present invention.

In FIG. 4 additional parameters are shown for mapping between a oneM2M system and an NGSI system: In FIG. 4 three entity attributes are shown named “conversionAutomated”, “conventionMethodUsed” and “conversionReliability”. Those parameters are used during the mapping and will be added to the NGSI attribute metadata after conversion to enable applications to identify automatically converted information.

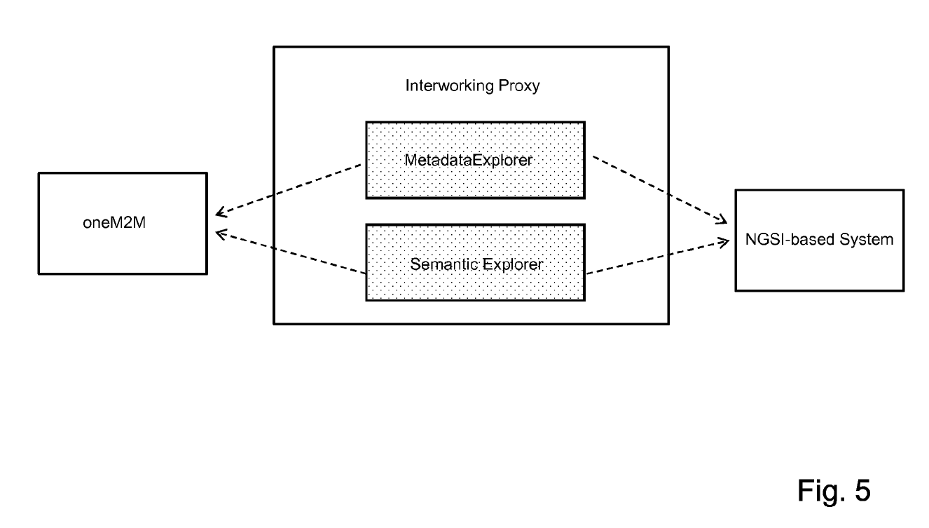

FIG. 5 shows a part of a system according to a further embodiment of the present invention.

In FIG. 5 the interworking proxy comprises instead of the conventional explorer of FIG. 3 a semantic explorer entity. The semantic explorer can identify oneM2M data structures being semantically annotated and may extract this annotated information to define the mapping. The semantic explorer entity may access the oneM2M system for finding semantically annotated data elements. Based on the semantics
NGSI Entity Id+Entity Type
NGSI Attribute Id+Type
Meta-data
   may be identified. If a suitable oneM2M data element is identified, it may then be announced to the NGSI-based system. Conversion attributes, e.g. “conversionAutomated”, “conventionMethodUsed”, and “conversionReliability” being used when Convention Mapping is performed may also be generated from the Semantic information.

The semantic explorer entity can be run periodically or be triggered by specific events, e.g. from the oneM2M system, e.g. when some semantic information has changed.

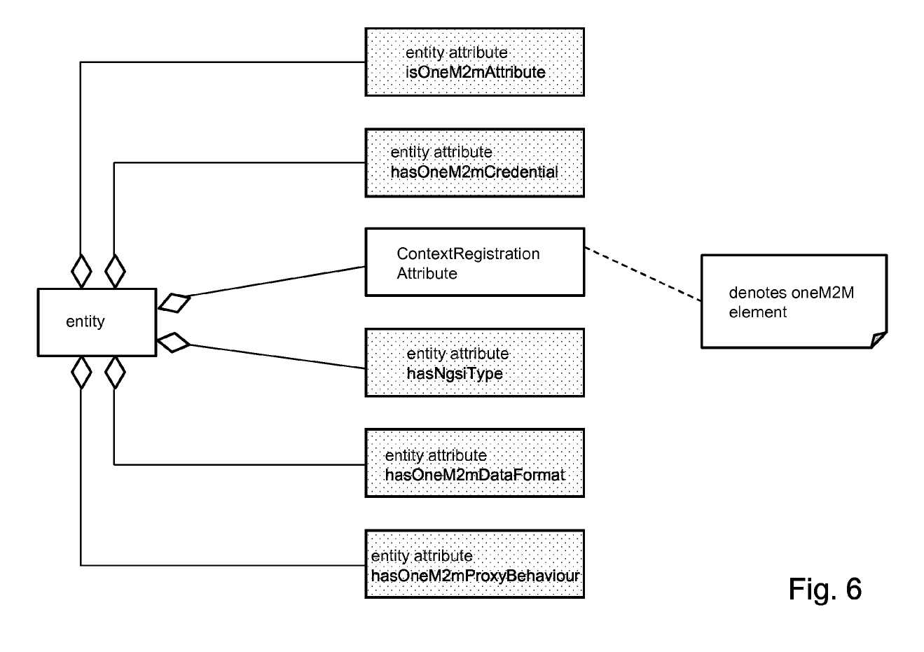

FIG. 6 shows a part of a system according to a further embodiment of the present invention.

In FIG. 6 different registry parameters as used in case of a data exposing system being an NGSI system are shown. In the following the data structure used during contextRegistration, the details of the context attributes as well as the metadata which are specified in the OMA standard, are shown.

| Element | | | |
|---|---|---|---|
| name | Element type | Optional | Description |
| EntityId | ctx:EntityId | No | List of identifiers for the |
| List | [1 . . . unbound] | | Context Entities being |
| | | | registered |
| Context | ctx:contextAttribute | No | List of ContextAttributes |
| Attribute | [1 . . . unbounded] | | and/or AttributeDomains |
| | | | which are made available |
| | | | through this registration. |
| Providing | xsd:anyURI | No | URI identifying the entity |
| Entity | | | that provides the values of |
| | | | the context attributes for the |
| | | | target Context Entities. |

| Element | | | |
|---|---|---|---|
| name | Element type | Optional | Description |
| Name | xsd:string | No | Name of the Context |
| | | | Information attribute |
| Type | xsd:string | No | Indicates the type of the |
| | | | value field |
| Context | xsd:any | No | The actual value of the |
| Value | | | Context Information |
| | | | attribute |
| Metadata | ctx:contextMetadata | Yes | Metadata about the Context |
| | [0 . . . unbounded] | | Information attribute |
| | | | (information valid only for |
| | | | the specific attribute) |

The context metadata structure is defined as follows:

| Element | | | |
|---|---|---|---|
| name | Element type | Optional | Description |
| Name | xsd:string | No | Name of the metadata. |
| Type | xsd:string | No | Indicates the type of the value field |
| Value | xsd:any or | No | The actual value of the metadata |
| | xsd:string | | |

Then for each NSGI attribute that should be retrieved from a oneM2M system the following metadata information is defined and shown in FIG. 6, while using existing attributes in a defined way:
(1) OneM2M Marker:
   This specifies a new metadata having the name “isOneM2MAttribute” of type boolean. If this metadata is present, the NGSI system knows that this attribute is provided by a oneM2M system. If it is not present, the NGSI system handles the attribute in a normal way.
(2) Change Usage of ProvidingEntity:
   If the “isOneM2MAttribute” is present then the ProvidingEntity attribute is a URI referencing a data item in a oneM2M system.
(3) oneM2M security credentials
   This new metadata is called “hasOneM2mCredential” comprising either the direct specification of oneM2M credentials, such as a userid/password combination, or a label identifying how the interworking entity can retrieve the information.
(4) NGSI Type: this new metadata defines the NGSI type to use for this attribute.
   [“hasNgsiType”:string]
(5) oneM2M conversion
   As oneM2M treats all application data as black boxes, a new metadata called “hasOneM2mDataFormat” is used to indicate to the interworking proxy how to convert a oneM2M data element into NGSI structures. It is of type string. It comprises a label that indicates to the interworking entity how to convert the data.
(6) oneM2M proxy behavior
   This metadata can be used to define how the interworking proxy should behave. Its name is “hasOneM2mProxyBehaviour”, it is of type string. The behavior is used to control how the proxy is accessing the information and how it is sent to the NGSI system.

In a further embodiment the present invention provides a system and method for implementing an interworking proxy comprising a MetaData Explorer which is driven by registration information in the DataExposureSystem comprising the steps of
1) Prepare: Inserting new metadata information into the registry;
   1.1 Insert semantic annotations into the DeviceControlling system containing the advanced attributes enabling discovery and mediations of the sensor information;
2) Retrieving the metadata information by the new module MetadataExplorer;
   2.1 Discovery & Filtering: Use the discovery function of the DeviceControlling system (or the DataExposingSystem system if conversion is done in the opposite directions) to find the elements that need to be converted and filter the list for the elements that have the needed attributed for automatic conversion;
   2.2 Fetch Meta Information: fetch meta-information from the discovered and filtered element. Use the meta-information to parameterize the conversion process;
   2.3 Translation: Translate the information from the origin system representation into the target system representation using the derived parameters and the conversion library; and
3) Store: Executing the data exchange between the DeviceControlling system and the DataExposingSystem using the API of the Data ExposingSystem.

In summary embodiments of the present invention enable a system comprising of an entity exposing system, preferably following the NGSI standard, a device managing system, preferably following the oneM2M system standard, and an interworking proxy or entity which can be equipped with different conversion units or modules. Further embodiments of the present invention enable additional conversion parameters to be stored in the data exposing system registry. Further embodiments of the present invention enable a conversion being in form of a metadata explorer which uses the previously mentioned parameters.

Even further embodiments of the present invention provide a method using NGSI subscribed notify messages in case the announcement information of the NGSI registry has changed. Further embodiments of the present invention enable a method being executed by the metadata explorer using the conversion parameter to retrieve the needed information from the device managing system. Further embodiments of the present invention enable an additional mapping editor to specify conversion parameters and insert them into the registry. Further embodiments of the present invention enable an additional conversion module previously called conversion explorer being invoked either periodically or on demand or on event. Further embodiments of the present invention enable the conversion explorer being adapted to analyze the oneM2M system and to generate and/or to update the conversion parameter or parameters.

Further embodiments of the present invention enable methods describing how the oneM2M conventions are analyzed for example the oneM2M application type is checked and application specific rules are applied. Further embodiments of the present invention enable a conversion with checking the name space of the representational state transfer REST resources for predefined patterns and generating the necessary conversion parameters. Even further embodiments of the present invention enable a conversion method testing given oneM2M data sources and if successful generating and/or modifying conversion parameters.

Further embodiments of the present invention enable internal and/or external services like a data conversion library comprising data conversion routines and/or a support knowledge base.

Even further embodiments of the present invention enable additional metadata to get inserted into entity attributes of the NGSI system comprising for example at least the parameters of FIG. 4.

Further embodiments of the present invention enable a conversion module named semantic explorer which can be invoked periodical and/or on demand and/or on event. Further embodiments of the present invention provide a method to explore the semantic information comprised in the oneM2M standard and generates the corresponding NGSI information.

In summary embodiments of the present invention enable
1) an architecture for an interworking proxy which is relying on information contained in the interworking systems (e.g. the NGSI Configuration Management or the Semantic Annotations in oneM2M), resulting in changing the data which is exchanged between the two systems as well as in the change of the data stores in the different systems;
2) a set of changes and data structures that can be added to the two systems. These new parameters are controlling the exchange process. Obtained results are additional data that get exchanged, as well as changes to the exchanged data itself. Furthermore, the speed of starting the data exchange can be improved;
3) a set of modules included into the Interworking Proxy. These modules implement various new methods for triggering and controlling the data exchange process; and
4) a set of additional internal and/or external components that can be used by the conversion modules.

Embodiments of the present invention enable or provide
an improved and new data exchange between oneM2M and NGSI systems
an efficient operation of the interworking proxy through reducing necessary calls to one of the systems
support tools for developer and system users in order to generate and install (into the NGSI or oneM2M system) the data that is steering the interworking processes like discovery operation or data exchange operation
support tools for the conversion methods.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An interworking entity (IE) for connecting at least two systems like networks, each system comprising at least one device, wherein the systems use data based on different data models, wherein the IE is adapted to convert data based on a first data model to data based on a second data model such that the data is processible by the respective devices in the systems, and wherein the IE is operable to:
a) evaluate mapping data within data to be transmitted from a first one of the at least two systems to a second one of the at least two systems; and
b) map, based on the evaluated mapping data, data compatible to the first data model from a first network to data compatible with the second data model.

2. The interworking entity according to claim 1, further comprising a first interface operable to communicate with a mapping editor entity via one of the systems, the mapping editor entity being adapted to provide a second interface operable to provide the mapping data needed for the mapping of a data element of the data by the IE.

3. The interworking entity according to claim 1, further comprising a convention explorer entity adapted to detect data elements which are mappable based on one or more rules.

4. The interworking entity according to claim 3, wherein the convention explorer entity is connected to a first database storing information for applying the rules on the detected data elements.

5. The interworking entity according to claim 1, further comprising a convention explorer entity adapted to detect data elements which are mappable based on one or more rules, wherein the convention explorer entity is connected to a second database storing mapping data for mapping and/or generating attribute information for the data elements according to sakfthe second data model.

6. The interworking entity according to claim 1, further comprising a convention explorer entity having a first and a second database.

7. The interworking entity according to claim 1, further comprising a semantic explorer entity adapted to find semantically annotated data elements such that mapping data for performing steps a) and b) is identifiable based on identified semantics in data elements mapping data.

8. The interworking entity according to claim 7, wherein the semantic explorer entity is adapted to perform the semantic finding periodically and/or upon request.

9. The interworking entity according to claim 1, wherein the mapping data comprises at least one of:
a network marker specifying the first and/or second network type;
security credentials specifying information how information for mapping is obtainable by the IE;
conversion information for the first and second network specifying how to convert the data;
proxy behavior information specifying how to access information and how to transmit information.

10. A method for connecting at least two systems like networks, each system comprising at least one device, wherein the systems use data with different data models, wherein data based on a first data model is at least partly converted to data according to a second data model such that the data is processible by the respective devices within the systems, wherein for data to be transmitted from a first network and based on the first data model to a second network, the method comprising:
inserting mapping data into registry information of the first network for the data to be transmittable to the second network,
b) discovering the data elements to be transmitted that need to be converted by an interworking entity (IE) located between and connected to each of the first and second systems,
c) extracting mapping data of the data elements, and
d) converting, based on the extracted mapping data, the data elements based on the first data model into data elements based on the second data model.

11. The method according to claim 10, wherein the first system is an NGSI system and wherein the second system is a oneM2M system.

12. The method according to claim 10, wherein the discovered data elements are filtered based on a parameter indicating automatic conversion.

13. The method according to claim 10, wherein, after the converting the data elements, the data is exchanged between the first and second system.

14. A non-transitory computer readable medium storing a program causing one or more processors, alone or in combination, to execute a method for connecting at least two systems like networks, each system comprising at least one device, wherein the systems use data with different data models, wherein data based on a first data model is at least partly converted to data based on a second data model such that the data is processible by the devices within the systems, wherein for data to be transmitted from a first network and based on the first data model to a second network, the method comprising:
a) inserting mapping data into registry information of the first network for the data to be transmittable to the second network,
b) discovering data elements to be transmitted that need to be converted by an interworking entity (IE) located between and connected to each of the first and second systems,
c) extracting mapping data of the data elements, and
d) converting, based on the extracted mapping data, the data elements based on the first data model into data elements based on the second data model.

15. A non-transitory computer readable medium storing a program causing one or more processors, alone or in combination, to execute a method for operating an interworking entity (IE) for connecting at least two systems like networks, each system comprising at least one device, wherein the systems use data based on different data models, wherein the IE is adapted to convert data based on a first data model to data based on a second data model such that the data is processible by the respective devices in the systems, wherein the program causes the IE to be operable to:
a) evaluate mapping data within data to be transmitted from a first one of the at least two systems to a second one of the at least two systems; and
b) map, based on the evaluated mapping data, data compatible to the first data model from a first network to data compatible with the second data model.
